(19) United States
(12) Patent Application Publication
(10) Pub. No.: US 2026/0162246 A1
(43) Pub. Date: Jun. 11, 2026

(54) GENERALIZED ZERO-SHOT DEFECT DETECTION FRAMEWORK USING SEMANTIC SEGMENTATION AND LOCAL DATABASE

(71) Applicant: SAP SE, Walldorf (DE)

(72) Inventors: Ankush Mishra, Singapore (SG); Xinyan Chen, Singapore (SG); Rajesh Vellore Arumugam, Singapore (SG); Anantharaman Ravi, Singapore (SG)

(21) Appl. No.: 18/969,362

(22) Filed: Dec. 5, 2024

(51) Int. Cl. G06T 7/00; G06T 7/10; G06V 10/25; G06V 10/74; G06V 20/70

(52) U.S. Cl. CPC G06T 7/001; G06T 7/0008; G06T 7/10; G06V 10/25; G06V 10/761; G06V 20/70; G06T 2207/30108

(57) ABSTRACT

Methods, systems, and computer-readable storage media for processing a target image and a reference image through a segmentation model to provide a set of target masks and a set of reference masks, and determining that a difference exists between a target mask and a reference mask, and in response, providing a potential defect patch for a ROI of the target image corresponding to the difference, generating a potential defect embedding using the potential defect patch, comparing the potential defect embedding to each defect embedding in a set of defect embeddings to provide a set of similarity scores, and selectively indicating presence of a defect in the product based on a similarity score in the set of similarity scores.

### BACKGROUND

Defect detection is performed in manufacturing processes in an effort to ensure that defective products do not make it to market. With the development of computer vision techniques, automatic visual inspection is enabled through the user of machine learning (ML) models. For example, defect detection models can be trained on visual inspection datasets to identify classes (e.g., types) and locations of defects on products. As such, labelled training data and a training process need be performed to provision such defect detection models. This incurs relatively high cost in terms of technical resources expended to provision such defect detection models. Further, such defect detection models are trained (or at least fine-tuned) for specific products. As such, multiple defect detection models must be provisioned, each defect detection model being specific to a respective product. This multiplies the already relatively high cost in terms of technical resources expended.

### SUMMARY

Implementations of the present disclosure are directed to a defect detection system for accurate identification and localization of defects in products. More particularly, implementations of the present disclosure are directed to a defect detection system that provides zero-shot defect detection to accurately identify and localize defects without the need for fine-tuning on domain-specific training data.

In some implementations, actions include receiving a target image depicting a product that is to-be-inspected for defects and a reference image depicting a product that is absent any defects, processing the target image through a segmentation model to provide a set of target masks and the reference image through the segmentation model to provide a set of reference masks, and determining that a difference exists between a target mask in the set of target masks and a reference mask in the set of reference masks, and in response, providing a potential defect patch for a region of interest (ROI) of the target image corresponding to the difference, generating a potential defect embedding using the potential defect patch, comparing the potential defect embedding to each defect embedding in a set of defect embeddings to provide a set of similarity scores, and selectively indicating presence of a defect in the product based on a similarity score in the set of similarity scores. Other implementations of this aspect include corresponding systems, apparatus, and computer programs, configured to perform the actions of the methods, encoded on computer storage devices.

These and other implementations can each optionally include one or more of the following features: selectively indicating presence of a defect in the product based on a similarity score in the set of similarity scores includes comparing the similarity score to a threshold similarity score, and indicating presence of a defect in response to the similarity score at least meeting the threshold similarity score; the similarity score is a maximum similarity score in the set of similarity scores; actions further include providing an output image that depicts the product of the target image with a bounding box indicating a location of the defect in the product and a label indicating a defect type of the defect; the label is determined from a registered defects database and is associated with a defect embedding that resulted in the similarity score; generating a potential defect embedding using the potential defect patch comprises processing the potential defect patch through an encoder that embeds the potential defect patch in an embedding space; each defect embedding in the set of defect embeddings is generated by the encoder; the segmentation model includes a pre-trained, third-party segmentation model; and determining that a difference exists between a target mask in the set of target masks and a reference mask in the set of reference masks comprises a pixel-wise comparison between pixels of the target mask and pixels of the reference mask.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for a defect detection system in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to a defect detection system for accurate identification and localization of defects in products. More particularly, implementations of the present disclosure are directed to a defect detection system that provides zero-shot defect detection to accurately identify and localize defects without the need for fine-tuning on domain-specific training data.

Implementations can include actions of receiving a target image depicting a product that is to-be-inspected for defects and a reference image depicting a product that is absent any defects, processing the target image through a segmentation model to provide a set of target masks and the reference image through the segmentation model to provide a set of reference masks, and determining that a difference exists between a target mask in the set of target masks and a reference mask in the set of reference masks, and in response, providing a potential defect patch for a region of interest (ROI) of the target image corresponding to the difference, generating a potential defect embedding using the potential defect patch, comparing the potential defect embedding to each defect embedding in a set of defect embeddings to provide a set of similarity scores, and selectively indicating presence of a defect in the product based on a similarity score in the set of similarity scores.

To provide further context for implementations of the present disclosure, and as introduced above, defect detection is performed in manufacturing processes in an effort to ensure that defective products do not make it to market. Defect detection can be described as the problem of identifying, localizing, and categorizing defective areas on products and is typically performed in a visual inspection phase of supply chains. Visual inspection can be described as the process of inspecting products in a production line to identify defects for quality control. Example defects can include, without limitation, surface defects (e.g., scratches, dents) and assembly defects (e.g., misaligned components, missing components) in manufacturing and automotive sectors, for example, insulator degradation in energy and utilities industry, for example, fabric tears in clothing production, for example, and the like.

With the development of computer vision techniques, automatic visual inspection is enabled through the user of machine learning (ML) models, such as deep neural networks (DNNs). Traditional defect detection systems can rely on fully supervised or semi-supervised ML models, which require large, well-labelled datasets and resource-intensive training. More particularly, object detection, segmentation, and classification models can be trained using a fully supervised learning strategy, which requires users to provide a well-labelled datasets that include both images of non-defective produces and images of defective products and their corresponding bonding boxes or segmentation masks. Such traditional defect detection systems face several technical challenges including high computational costs, the need for extensive labelled data, and difficulties adapting to different domains or defect types.

Further, due to a lack of prior knowledge, the object detection and segmentation models need to process the whole image to localize any defects and propose regions of interest (ROIs) for further investigation. In most visual inspection cases, a defect on a product only occupies a small area. However, the object detection and segmentation model needs to recursively go through the ROI proposal process to finalize the location of the defect. Such a process incurs high computational costs and inference results can be imprecise.

In view of the above context, implementations of the present disclosure provide a defect detection system that provides zero-shot defect detection to accurately identify and localize defects without the need for fine-tuning on domain-specific training data. Leveraging the stationary nature of cameras in inspection areas and retaining contextual knowledge from at least one defective sample, the defect detection system generalizes across various domains and detects defects in diverse products without training using extensive labelled datasets. This approach not only reduces the reliance on large-scale annotated data but also enhances the adaptability and efficiency of the defect detection system, improving runtime performance across various industrial applications. While traditional approaches often overfit when fine-tuned on sparse datasets, the defect detection system of the present disclosure excels in accuracy with as few as one labelled example. As such, the defect detection system of the present disclosure leads to more reliable and cost-effective quality control processes.

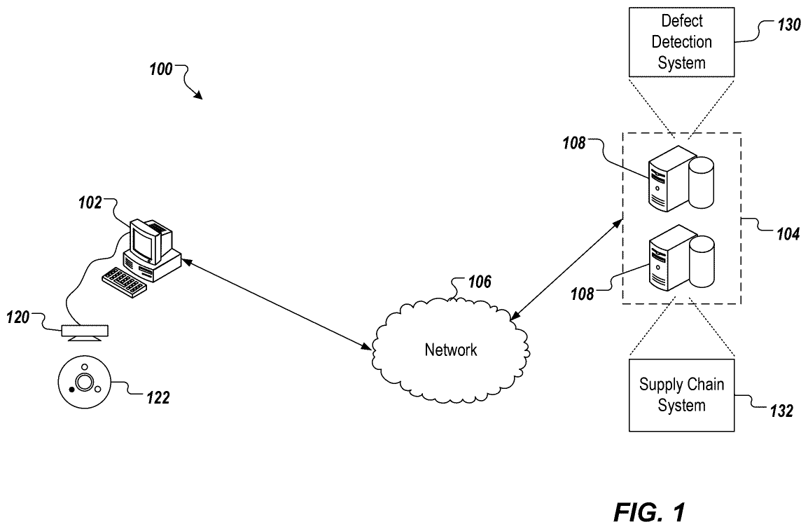

FIG. 1 depicts an example system 100 that can execute implementations of the present disclosure. The example system 100 includes a computing device 102, a back-end system 104, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the back-end system 104 includes at least one server system 108 (e.g., with a data store). In some examples, the at least one server system 108 hosts one or more computer-implemented services that users can interact with using computing devices. For example, the server system 108 can host a defect detection system in accordance with implementations of the present disclosure.

In the example of FIG. 1, a camera 120 and an object 122 are depicted. The camera 120 can by any appropriate type of camera (e.g., video camera) that generates images representing objects, such as the object 122. In the context of the present disclosure, the camera 120 can generate images as digital data representing the object 122. The camera 120 can capture images of every side of the object 122, such as front, back, left, right, top, and bottom sides of the object 122. In some examples, multiple cameras 120 installed in different angles can be provided to capture images of every side of the object 122. In some examples, the object 122 can be rotated, so that the camera 120 can capture images of every side of the object 122.

In accordance with implementations, images can be processed by a defect detection system 130 to determine whether the object 122, as represented within the image(s), includes any defects. In some examples, the defect detection system 130 is executed in the back-end system 104. It is contemplated that at least a portion of the defect detection system 130 is executed on the computing device 102. As described in further detail herein, the defect detection system 130 provides zero-shot defect detection to accurately identify and localize defects without the need for fine-tuning on domain-specific training data. In some examples, a supply chain system 132 is executed in the back-end system 104. It is contemplated that at least a portion of the supply chain system 132 is executed on the computing device 102. In some examples, the object 122 is included in a supply chain that is managed by the supply chain system 132. In some examples, the supply chain system 132 records images of products, such as the object 122, included in the supply chain and provides images to the defect detection system 130, which detects defects in products, as described in further detail herein.

Implementations of the present disclosure are described in further detail with reference to an example product that includes a valve head. For example, a defect detection system of the present disclosure can be used for quality assurance by visual inspection during assembly of valve heads to detect defects occurring in the assembly process. In this example, the assembly process includes assembling three screws, one cap, and one sticker for each valve head. In this example, quality assurance typically identifies defects of missing screws, an absent plate, a missing sticker, and the like. It is contemplated, however, that implementations of the present disclosure can be realized with any appropriate product and respective process (e.g., assembly process, manufacturing process).

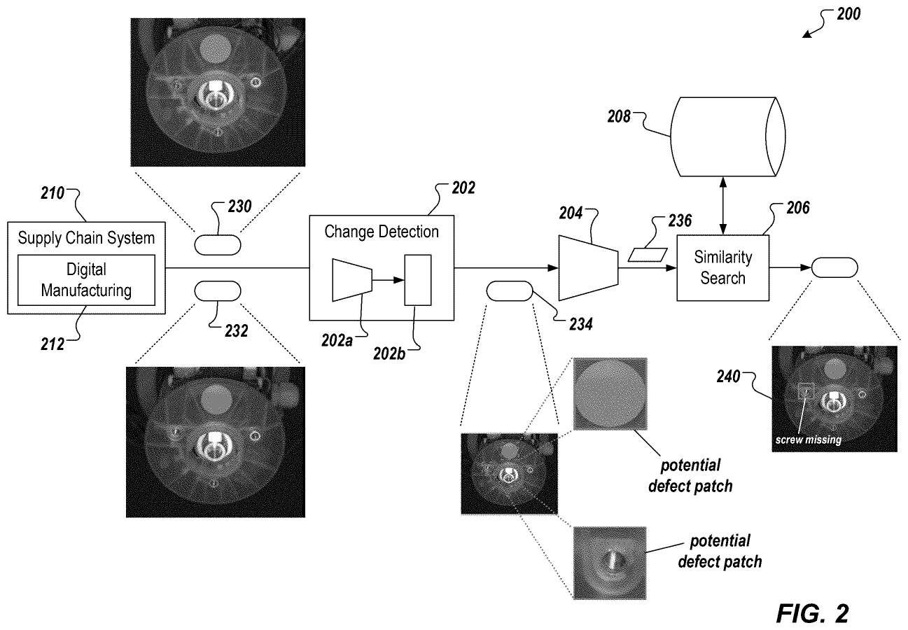

FIG. 2 depicts an example conceptual architecture 200 for a defect detection system in accordance with implementations of the present disclosure. In the depicted example, conceptual architecture 200 includes a change detection module 202, an encoder 204, a similarity search module 206, a registered defects database 208, which can collectively constitute a defect detection system (e.g., the defect detection system 130 of FIG. 1). In the example of FIG. 2, the example conceptual architecture 200 includes a supply chain system 210 (e.g., the supply chain system 132 of FIG. 1) that includes a digital manufacturing sub-system 212. An example supply chain system can include, without limitation, SAP Supply Chain Management (SCM) provided by SAP SE of Walldorf, Germany.

As described in further detail herein, the task of the defect detection system is to accurately determined whether one or more defects are present in a product, such as a valve head, and, if a defect is present, to accurately locate and classify the defect(s). To determine a type and location of a defect, the defect detection system of the present disclosure uses a set of defect images, each defect image depicting a non-conformant (defective) product, a reference image depicting a conformant (non-defective) product, and a target image depicting a product that is to be inspected.

In accordance with implementations of the present disclosure, the registered defects database 208 stores defect embeddings, each defect embedding corresponding to a ground-truth label of a defect. In some examples, a set of defect images is provided, each defect image depicting one or more defects in a product. In some examples, each defect image is associated with one or more ground-truth labels, each ground-truth label indicating a type of defect. For each defect in a defect image, a defect patch is extracted and is sized to standardized dimensions (e.g., pixel height, pixel width). In some examples, defect patches are extracted by cropping out regions specified in the ground truth-labels of the image. In some examples, a defect patch is encompassed within a bounding box and depicts a defect of a defect image. For each defect patch, a defect embedding is generated.

In some examples, a defect patch is processed through an encoder that embeds the defect patch in a multi-dimensional embedding space to provide a defect embedding. Each defect embedding is provided as a multi-dimensional vector representation of a defect patch. In some examples, the embedder is provided as a pre-trained, frozen encoder (e.g., frozen meaning that parameters of the embedder are not changed after training). In some examples, the encoder used to generate the defect embeddings is the encoder 204. A non-limiting example of an embedder includes a vision transformer (ViT). The defect embeddings are registered in the registered defects database 208 and are categorized by defect type. In some examples, if multiple defect embeddings are provided for a defect type, the defect embeddings are averaged to provide a defect embedding representative of the defect type.

Accordingly, the registered defects database 208 provides a set of defect types and, for each defect type, a defect embedding to provide a set of defect embeddings ({E_{reg_1} . . . , E_{reg_n}}). For the example product of a valve head, the following example defect registration table can be maintained in the registered defects database 208:

TABLE 1
Example Defect Registration Table

| Defect Type | Embedding |
|---|---|
| Screw Missing | E_{reg}_{_{—}}₁ |
| Plate Missing | E_{reg}_{_{—}}₂ |
| Sticker Missing | E_{reg}_{_{—}}₃ |
| Sticker Misplaced | E_{reg}_{_{—}}₄ |
| Plate Scratched | E_{reg}_{_{—}}₅ |
| Plate Dented | E_{reg}_{_{—}}₆ |
| . . . | . . . |

As described in further detail herein, embeddings determined from target images can be compared to defect embeddings stored in the registered defects database 208 to determine defect types represented in target images.

In further detail, and as described in further detail herein, the change detection module 202 detects variations between images, each variation indicative of a potential defect. More particularly, for each product, the change detection module 202 processes a reference image 230 and a target image 232 to provide an output image 234. In some examples, the reference image 230 depicts a sample of a product that is absent any defects (e.g., an image of the product from a standard product database). In some examples, the target image 232 depicts a product that is to-be-inspected for any defects (e.g., a product moving down or exiting an assembly line). In some examples, if the product that is to-be-inspected is suspected of including a defect, the output image 234 depicts the product with one or more masks, each mask depicting an area of a possible defect.

The change detection module 202 receives the reference image 230 and the target image 232 and identifies ROIs in the target image 232 by comparing the target image 232 to the reference image 230 at the pixel level. In the example of FIG. 2, the change detection module 202 includes a segmentation head 202a and a mask difference module 202b.

In some examples, the segmentation head 202a generates segmentation masks for both the reference image 230 and the target image 232. That is, each of the reference image 230 and the target image 232 is processed through the segmentation head 202a, which provides a set of reference masks and a set of target masks, respectively. The mask differencing module 202b applies pixel-level differencing between the masks in the set of reference masks and masks in the set of target masks. Based on the extent of the differing masks, the mask differencing module 202b proposes one or more bounding boxes in the target image 232, each bounding box encompassing a ROI, each ROI indicating an area where a defect may be present.

In some examples, the segmentation head 202a includes one or more ML models, such as convolution neural networks (CNNs) and generative adversarial networks (GANs). In general, the segmentation head 202a includes an image encoder, a decoder, and a mask decoder. A non-limiting example of a segmentation head includes the Segment Anything Model (SAM) provided by Meta. Accordingly, the segmentation head 202a can be provided as a pre-trained, third-party segmentation model.

In some examples, the mask differencing module 202b determines a difference between the mask(s) of the reference image 230 and the mask(s) of the target image 232 at the pixel level. For example, there is consistency in position of the object, such that images are captured with objects in the same location and same orientation. This setup is typically achieved in manufacturing assembly lines, for example, where a stationary camera photographs objects from a fixed position at different times. Leveraging the stable position of the inspection camera, the masks corresponding to features (e.g., screws, stickers) appear in consistent locations across images. Consequently, the mask differencing module 202b can directly subtract the segmented outputs without needing to isolate individual mask patches. In some examples, if there is a misalignment in mask placement between the reference and target images—meaning that the overlapping mask region has an intersection over union (IoU) score below a decision threshold (e.g., 0.95)—the mask is flagged as a potential defect region. By determining the boundaries of this misaligned mask, the bounding box for the potential defect can be determined.

Accordingly, if there is a difference between a mask of the reference image 230 and a mask of the target image 232, a ROI is provided and is representative of a location of the difference within the target image 232. In some examples, each ROI can be described as a potential defect patch and depicts a portion of the target image 232 that is suspected of depicting a defect. Each potential defect patch is processed through the encoder 204 to provide a potential defect embedding. Each defect embedding is provided as a multi-dimensional vector representation of a potential defect patch. As noted above, the defect embeddings stored in the registered defects database 208 are also generated using the encoder 204. As such, the defect embeddings and the potential defect embeddings are embedded in the same embedding space and are of the same dimensions.

In accordance with implementations of the present disclosure, each potential defect embedding that is provided for the target image is compared to the defect embeddings stored in the registered defects database 208 to determine whether the potential defect embedding sufficiently matches any defect embedding. More particularly, the similarity search module 206 receives a set of potential defect embeddings 236 (e.g., including one or more potential defect embeddings) from the encoder 204 and the set of defect embeddings from the registered defects database 208. In some examples, the similarity search module 206 compares each potential defect embedding to each defect embedding to provide a similarity score. In some examples, each similarity score is generated using cosine similarity.

Accordingly, a set of similarity scores is provided, each similarity score representing a degree of similarity between a potential defect embedding and a defect embedding. Here, each set of similarity scores corresponds to a potential defect embedding and, thus, a ROI. For example, if the target image 232 results in a first ROI and a second ROI, a first potential defect embedding E_{pot_1} is provided for the first ROI and a second potential defect embedding E is provided for the second ROI. The first potential defect embedding is compared to each embedding in the set of defect embeddings to provide a first set of similarity scores ({s_{1,1}, . . . , s_{1,n}}), and the second potential defect embedding is compared to each embedding in the set of defect embeddings to provide a second set of similarity scores ({s_{2,1}, . . . , s_{2,n}}).

In some implementations, for a set of similarity scores, a maximum similarity score is determined and is compared to a threshold similarity score. If the maximum similarity score meets or exceeds the threshold similarity score, the respective ROI is classified as defective and is assigned a defect type corresponding to the respective defect embedding. If the maximum similarity score does not meet or exceed the threshold similarity score, the ROI is considered as non-defective. This can indicate that there is either no defect present in the ROI or that a defect in the ROI is not listed in the registered defects database 208.

To illustrate this, the example introduced above can be considered, in which are provided the first set of similarity scores ({s_{1,1}, . . . , s_{1,n}}) for the first potential defect of the first ROI and the second set of similarity scores ({s_{2,1}, . . . , s_{2,n}}) for the second potential defect of the second ROI. It can be determined that s_{1,1} of the first set of similarity scores meets or exceeds the threshold similarity score and that none of the similarity scores of the second set of similarity scores meets or exceeds the threshold similarity score. In this example, it can be determined that the first ROI depicts a ‘screw missing’ defect and that the second ROI either depicts no defect or an unregistered defect. For example, the first ROI can be identified, because a screw is missing from the valve head depicted in the target image 232 and is correctly classified as a ‘screw missing’ defect. On the other hand, the second ROI can be identified, because a sticker is slightly misaligned on the valve head depicted in the target image 232 (as compared to the reference image 230), but misalignment of stickers is not considered a defect (hence, is unregistered).

As depicted in the FIG. 2, if a defect is identified within an ROI, an output image 240 can be provided that includes bounding boxes encompassing defects detected in the product. In some examples, each bounding box can be labelled with a defect type. The example output image 240 of FIG. 2 represents the example above, in which a first ROI is determined to have a ‘screw missing’ defect. As such, a bounding box encompassing a location missing a screw is provided in the output image 240. However, and because a misaligned sticker is not considered a defect, no bounding box is provided for the second ROI within the output image 240.

In some implementations, if no defect is identified in the target image 232, the product is indicated as non-defective. In some examples, the defect detection system can provide a message to the supply chain system 210 that indicates that no defects were detected in the target image 232. In some implementations, if one or more defects are identified in the target image 232, the product is indicated as defective. In some examples, the defect detection system can provide a message to the supply chain system 210 that indicates that the product is defective and that includes the output image 240 with, for each defect detected, a bounding box and a label indicating a defect type.

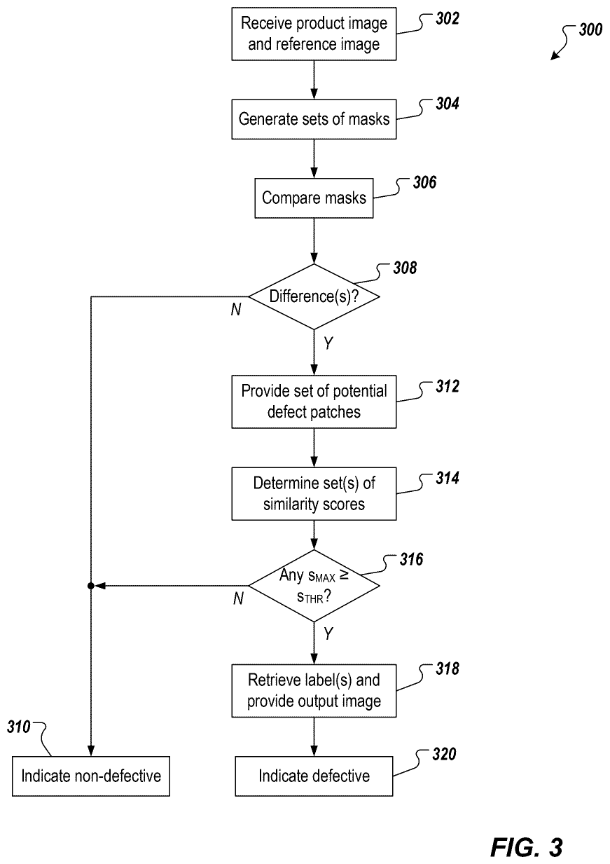

FIG. 3 depicts an example process 300 that can be executed in accordance with implementations of the present disclosure. In some examples, the example process 300 is provided using one or more computer-executable programs executed by one or more computing devices.

A target image and reference image are received (302). For example, and as described in detail herein with reference to FIG. 2, the change detection module 202 receives the target image 232 from the supply chain system 210. In some examples, the target image 232 depicts a product that is to-be-inspected and is generated by a camera (e.g., the camera 120 of FIG. 1 generating a product image depicting the object 122). In some examples, the change detection module 202 receives the reference image 230 from the supply chain system 210, and the reference image 230 depicts a product (the same type of product depicted in the target image 232) that is absent any defects.

A set of masks is generated (304) and the masks are compared to determine whether there are any differences (306). For example, and as described herein, each of the reference image 230 and the target image 232 is processed through the segmentation head 202a, which provides a set of reference masks and a set of target masks. The mask differencing module 202b applies pixel-level differencing between the masks in the set of reference masks and masks in the set of target masks. It is determined whether there are any differences (308). If there are no differences, the product is indicated as non-defective (310). For example, and as described herein, the defect detection system can provide a message to the supply chain system 210 that indicates that no defects were detected in the target image 232.

If there is one or more differences, a set of potential defect patches is provided (312). For example, and as described herein, based on the extent of the differing masks, the mask differencing module 202b proposes one or more bounding boxes in the target image 232, each bounding box encompassing a ROI, each ROI indicating an area where a defect may be present. For each ROI, a potential defect patch is provided, which depicts a portion of the target image 232 that is suspected of depicting a defect.

One or more sets of similarity scores is determined (314). For example, and as described herein, the encoder 204 provides a potential defect embedding for each potential defect patch, which is provided to the similarity search module 206. The similarity search module 206 compares each potential defect embedding to each defect embedding in a set of defect embeddings stored in the registered defects database. In this manner, for each potential defect embedding, a set of similarity scores is provided.

It is determined whether a maximum similarity score (s_{MAX}) of a set of similarity scores meets or exceeds a threshold similarity score (s_{THR}) (316). For example, and as described herein, for a set of similarity scores, a maximum similarity score is determined and is compared to the threshold similarity score. If there are multiple sets of similarity scores (e.g., multiple potential defects are detected), this is done for each set of similarity scores.

If no maximum similarity score (s_{MAX}) meets or exceeds the threshold similarity score (s_{THR}), the product is indicated as non-defective (310). If a maximum similarity score (s_{MAX}) meets or exceeds the threshold similarity score (s_{THR}), a label is retrieved and an output image is provided (318). For example, and as described herein, a defect type label of the defect embedding that resulted in the maximum similarity score is provided from the registered defect database 208. An output image is provided that includes a bounding box around the potential defect patch (the ROI) and the defect type label is associated with the bounding box in the output image. In this manner, the output image indicates the location of the defect in the product and the defect type that is detected. The product is indicated as defective (320). For example, and as described herein, the defect detection system can provide a message to the supply chain system 210 that indicates that the product is defective and that includes the output image 240 with, for each defect detected, a bounding box and a label indicating a defect type.

Implementations of the present disclosure provide multiple technical advantages. For example, the defect detection system of the present disclosure effectively handles defects across diverse domains, even in the presence of substantial distribution shifts between datasets, without necessitating domain-specific adjustments. As another example, the zero-shot nature of the defect detection system of the present disclosure eliminates the need for fine-tuning of defect detection models, which reduces computational costs and streamlines the detection process. As another example, the defect detection system of the present disclosure performs robustly with minimal data (data sparsity), using only one conformant (non-defective) sample (reference image) and at least one labeled non-conformant (defective) sample (used to generate a defect embedding stored in the registered defects database), demonstrating efficiency with sparse datasets.

As still another example, the defect detection system of the present disclosure is absent any pretrained object detection model. More particularly, and in contrast to even the most advanced object detections methods, the defect detection system of the present disclosure does not rely on any object detection model as a backbone or utilize their pre-trained weights. Instead, and as described herein, the defect detection system of the present disclosure adopts a novel strategy by leveraging a pre-trained segmentation model. This framework capitalizes on the stationary nature of inspection cameras and utilizes contextual knowledge from a single defective sample to achieve effective localization and classification. As yet another example, by circumventing the need for model retraining or fine-tuning, the defect detection system of the present disclosure ensures significantly faster end-to-end processing compared to traditional object detection models, which often require domain-specific adaptations (e.g., retraining and/or fine-tuning for each individual product that is to be visually inspected).

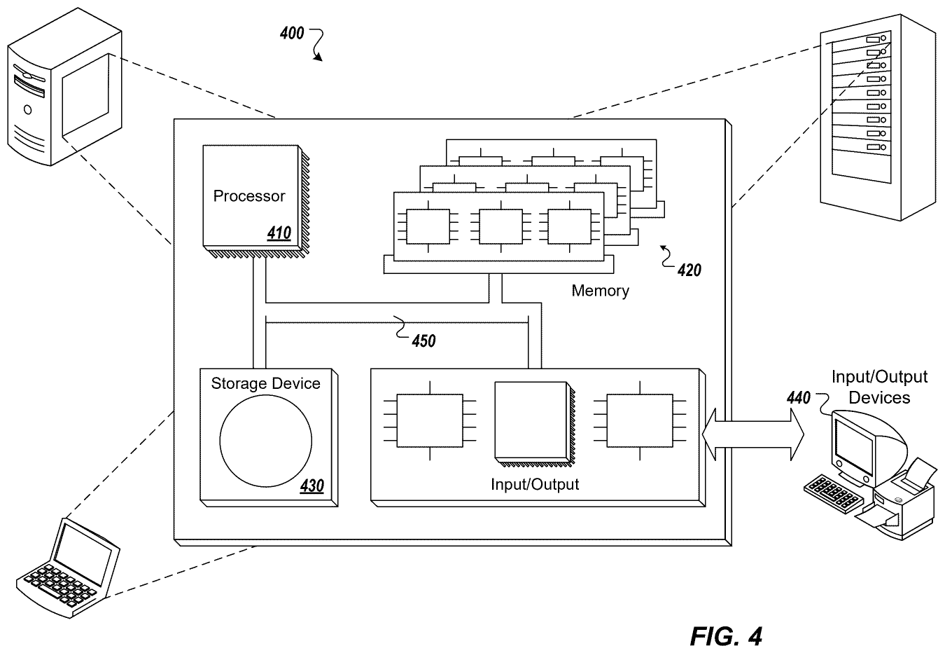

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automated visual inspection of products for defects, the method being executed by one or more processors and comprising:
receiving a target image depicting a product that is to-be-inspected for defects and a reference image depicting a product that is absent any defects;
processing the target image through a segmentation model to provide a set of target masks and the reference image through the segmentation model to provide a set of reference masks; and
determining that a difference exists between a target mask in the set of target masks and a reference mask in the set of reference masks, and in response:
providing a potential defect patch for a region of interest (ROI) of the target image corresponding to the difference,
generating a potential defect embedding using the potential defect patch,
comparing the potential defect embedding to each defect embedding in a set of defect embeddings to provide a set of similarity scores, and
selectively indicating presence of a defect in the product based on a similarity score in the set of similarity scores.

2. The method of claim 1, wherein selectively indicating presence of a defect in the product based on a similarity score in the set of similarity scores comprises:
comparing the similarity score to a threshold similarity score; and
indicating presence of a defect in response to the similarity score at least meeting the threshold similarity score.

3. The method of claim 2, wherein the similarity score is a maximum similarity score in the set of similarity scores.

4. The method of claim 1, further comprising providing an output image that depicts the product of the target image with a bounding box indicating a location of the defect in the product and a label indicating a defect type of the defect.

5. The method of claim 4, wherein the label is determined from a registered defects database and is associated with a defect embedding that resulted in the similarity score.

6. The method of claim 1, wherein generating a potential defect embedding using the potential defect patch comprises processing the potential defect patch through an encoder that embeds the potential defect patch in an embedding space.

7. The method of claim 6, wherein each defect embedding in the set of defect embeddings is generated by the encoder.

8. The method of claim 1, wherein the segmentation model comprises a pre-trained, third-party segmentation model.

9. The method of claim 1, wherein determining that a difference exists between a target mask in the set of target masks and a reference mask in the set of reference masks comprises a pixel-wise comparison between pixels of the target mask and pixels of the reference mask.

10. A non-transitory computer-readable storage medium coupled to one or more processors and having instructions stored thereon which, when executed by the one or more processors, cause the one or more processors to perform operations for automated visual inspection of products for defects, the operations comprising:
receiving a target image depicting a product that is to-be-inspected for defects and a reference image depicting a product that is absent any defects;
processing the target image through a segmentation model to provide a set of target masks and the reference image through the segmentation model to provide a set of reference masks; and
determining that a difference exists between a target mask in the set of target masks and a reference mask in the set of reference masks, and in response:
providing a potential defect patch for a region of interest (ROI) of the target image corresponding to the difference,
generating a potential defect embedding using the potential defect patch,
comparing the potential defect embedding to each defect embedding in a set of defect embeddings to provide a set of similarity scores, and
selectively indicating presence of a defect in the product based on a similarity score in the set of similarity scores.

11. The non-transitory computer-readable storage medium of claim 10, wherein selectively indicating presence of a defect in the product based on a similarity score in the set of similarity scores comprises:
comparing the similarity score to a threshold similarity score; and
indicating presence of a defect in response to the similarity score at least meeting the threshold similarity score.

12. The non-transitory computer-readable storage medium of claim 11, wherein the similarity score is a maximum similarity score in the set of similarity scores.

13. The non-transitory computer-readable storage medium of claim 10, wherein operations further comprise providing an output image that depicts the product of the target image with a bounding box indicating a location of the defect in the product and a label indicating a defect type of the defect.

14. The non-transitory computer-readable storage medium of claim 13, wherein the label is determined from a registered defects database and is associated with a defect embedding that resulted in the similarity score.

15. The non-transitory computer-readable storage medium of claim 10, wherein generating a potential defect embedding using the potential defect patch comprises processing the potential defect patch through an encoder that embeds the potential defect patch in an embedding space.

16. The non-transitory computer-readable storage medium of claim 10, wherein each defect embedding in the set of defect embeddings is generated by the encoder.

17. A system, comprising:
a computing device; and
a computer-readable storage device coupled to the computing device and having instructions stored thereon which, when executed by the computing device, cause the computing device to perform operations for automated visual inspection of products for defects, the operations comprising:
receiving a target image depicting a product that is to-be-inspected for defects and a reference image depicting a product that is absent any defects;
processing the target image through a segmentation model to provide a set of target masks and the reference image through the segmentation model to provide a set of reference masks; and
determining that a difference exists between a target mask in the set of target masks and a reference mask in the set of reference masks, and in response:
providing a potential defect patch for a region of interest (ROI) of the target image corresponding to the difference,
generating a potential defect embedding using the potential defect patch,
comparing the potential defect embedding to each defect embedding in a set of defect embeddings to provide a set of similarity scores, and
selectively indicating presence of a defect in the product based on a similarity score in the set of similarity scores.

18. The system of claim 17, wherein selectively indicating presence of a defect in the product based on a similarity score in the set of similarity scores comprises:
comparing the similarity score to a threshold similarity score; and
indicating presence of a defect in response to the similarity score at least meeting the threshold similarity score.

19. The system of claim 18, wherein the similarity score is a maximum similarity score in the set of similarity scores.

20. The system of claim 17, wherein operations further comprise providing an output image that depicts the product of the target image with a bounding box indicating a location of the defect in the product and a label indicating a defect type of the defect.
